(19) United States
(12) Patent Application Publication
(10) Pub. No.: US 2014/0321290 A1
(43) Pub. Date: Oct. 30, 2014

(54) MANAGEMENT OF CLASSIFICATION FRAMEWORKS TO IDENTIFY APPLICATIONS

(71) Applicant: HEWLETT-PACKARD DEVELOPMENT COMPANY, L.P., Houston, TX (US)

(72) Inventors: Tao JIN, Boston, MA (US); Jung Gun Lee, Mountain View, CA (US); Gowtham Bellala, Mountain View, CA (US)

(73) Assignee: Hewlett-Packard Development Company, L.P., Houston, TX (US)

(21) Appl. No.: 13/874,328

(22) Filed: Apr. 30, 2013

(51) Int. Cl. H04L 12/851

(52) U.S. Cl. CPC H04L 47/2441
USPC 370/241

(57) ABSTRACT

According to an example, a classification framework to identify an application name may be managed by accessing network flow information collected at a client device by an agent installed on the client device, in which the network flow information is information corresponding to network traffic that is at least one of communicated and received by an application running on the client device, accessing flow features of a plurality of packets that are at least one of communicated and received by the application, and creating training data for a classifier based upon a correlation of the network flow information and the flow features of the plurality of packets.

### BACKGROUND

There has been explosive growth in the amount and types of traffic communicated over networks with the rapid expansion of mobile data networks and capabilities of hardware in mobile devices. One result of this growth is that users readily download large amounts of content from the Internet to their devices as well as upload large amounts of data from their devices over the Internet. Network traffic pattern classification techniques have been introduced and developed to handle the quickly changing network traffic patterns and resource demands resulting from this growth in content transfer. These classification techniques include port based classification, deep packet inspection, and machine learning classification.

### BRIEF DESCRIPTION OF THE DRAWINGS

Features of the present disclosure are illustrated by way of example and not limited in the following figure(s), in which like numerals indicate like elements, in which:

FIG. 1 depicts a simplified block diagram of a network, which may contain various components for implementing various features disclosed herein, according to an example of the present disclosure;

FIG. 2 depicts a simplified block diagram of the classification server depicted in FIG. 1, according to an example of the present disclosure;

FIGS. 3 and 4A-4B, respectively, depict flow diagrams of methods of managing a classification framework to identify an application name, according to examples of the present disclosure; and

FIG. 5 illustrates a schematic representation of a computing device, which may be employed to perform various functions of the classification server depicted in FIGS. 1 and 2, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are methods and apparatuses of managing a classification framework to identify an application name. The methods and apparatuses disclosed herein may create accurate training data, e.g., ground truth data, for a classifier by accessing both applications running on client devices and flow features associated with the applications and annotating the application names with their associated flow features. In this regard, the methods and apparatuses disclosed herein may generate ground truth data for a machine learning classifier that is to identify network traffic types of packets flowing through a network. In addition, the methods and apparatuses disclosed herein may generate additional ground truth data over time such that the classifier may be re-trained, for instance, as network traffic pattern changes in the applications occur, as new applications are installed and implemented in client devices, etc. According to an example, the updating of the training data and the re-training of the classifier may be performed automatically. In contrast, conventional classifiers, such as Deep Packet Inspection (DPI) based classifiers, require a greater level of human involvement for the classifiers to be updated.

According to an example, an agent is installed in each of a plurality of client devices to collect network flow information corresponding to applications running on the client devices that access a network, such as the Internet. The network flow information may include, for instance, the network socket and a name of the application using the network socket. The agents may generate agent logs containing the network flow information and may communicate the agent logs to a classification server at various intervals of time. The classification server may also access flow features of packet flows and may correlate the flow features to the application names. The classification server may further generate training data for a classifier, such as a machine learning classifier, using the correlation of the flow features and the application names. In addition, because the network flow information may be received from multiple client devices, a crowd sourcing approach may be employed to generate the accurate training data. That is, the flow information received from the multiple client devices may be used to generate the accurate training data.

Through implementation of the methods and apparatuses disclosed herein, accurate ground truth data to be implemented in training a classifier may be generated. The ground truth data may also be generated at a relatively fine grain level, i.e., at the application level. In addition, the classifier may learn a classification rule using the training data to distinguish different network traffic (or, equivalently) application names based upon flow features of packets flowing through a network. The resulting network traffic classification may then be effectively used for any of service differentiation, network engineering, security, accounting, etc.

The classifier disclosed herein may predict the application names based upon a set of flow features (or statistics) and not the packet content payload. As such, the classifier may operate with a relatively low computational cost and may reliably handle encrypted network traffic. In addition, the application name may be identified as early as possible using a relatively small amount of information from the flow features, such as the top few packet sizes, minimum/maximum/mean packet size of the top few packets, etc.

In the present disclosure, implementations discussed in relation to application names may also apply to application types such as voice over IP (VoIP), instant messaging, video streaming, etc. That is, for instance, application types may be identified based upon the set of flow features used to predict application names. By way of particular example, the application types may be identified through a mapping, e.g., a manual mapping, from each application name to application type. For instance, a number of video streaming application names may be mapped to the video streaming type.

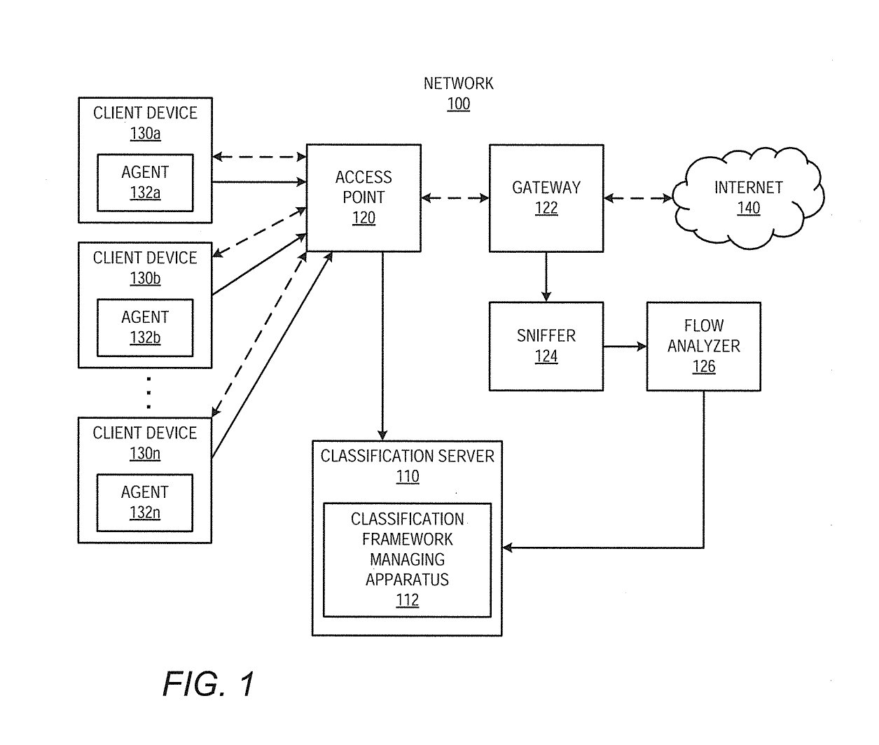

With reference first to FIG. 1, there is shown a simplified block diagram of a network 100, which may contain various components for implementing various features disclosed herein, according to an example. It should be understood that the network 100 may include additional elements and that some of the elements depicted therein may be removed and/or modified without departing from a scope of the network 100.

The network 100 is depicted as including a classification server 110, an access point 120, a gateway 122, a sniffer 124, and a flow analyzer 126. The network 100 may represent any type of network, such as a wide area network (WAN), a local area network (LAN), etc., over which frames of data, such as Ethernet frames or packets may be communicated. As shown in FIG. 1, a plurality of client devices 130a-130n, in which “n” represents an integer greater than 1, may access the Internet 140 through the network devices, e.g., access point 120 and gateway 122, of the network 100. In addition, the client devices 130a-130n may be any of smart phones, tablet computers, personal computers, laptop computers, etc. By way of example, users may run various applications on the client devices 130a-130n, which may send packets of data to servers (not shown) over the Internet 140 and may receive packets of data from the servers as indicated by the dashed arrows in FIG. 1. The applications may be any of various applications that users may run on the client devices 130a-130n, such as streaming video applications, streaming audio applications, communication applications, image and photo applications, data storage applications, file download applications, etc.

As also shown in FIG. 1, the classification server 110 may include a classification framework managing apparatus 112. Generally speaking, the classification framework managing apparatus 112 is to collect various data and information from various components as denoted by the solid arrows in FIG. 1. In addition, the classification framework managing apparatus 112 is to generate or create a classification framework that may be employed to identify application names. The classification framework may include training data that a classifier may use to learn flow features of application names. The classification framework may also include the classifier itself. In one regard, the classification framework managing apparatus 112 may create training data for a classifier using the collected data and information. Particularly, the classification framework managing apparatus 112 may create accurate training data, which is also referred herein as ground truth data, that a classifier, such as a machine learning classifier, may use in learning the features of a particular type of flow, such as the source IP, destination IP, sizes of a top few packets, etc., corresponding to each of a plurality of application names. In other words, the classifier may try to learn a feature signature corresponding to each of the plurality of application names based upon the feature values. The classification framework managing apparatus 112 is discussed in greater detail herein below.

As also shown in FIG. 1, a sniffer 124 may capture network traffic flowing through the gateway 122. Alternatively, however, the sniffer 124 may capture network traffic flowing through other network devices in the network 100, such as routers, hubs, switches, firewalls, servers, etc. In any regard, the sniffer 124 may be any suitable device and/or machine readable instructions stored on a device that is/are to capture network traffic and to generate packet capture (pcap) logs. In addition, the sniffer 124 may forward the pcap logs to the flow analyzer 126, which may be any suitable device and/or machine readable instructions stored on a device that is/are to analyze the pcap logs. The flow analyzer 126 may extract flow features (or statistics) from the network flows identified in the pcap logs.

By way of particular example, the flow analyzer 126 may extract the following flow features (or statistics) from the network flow:

Source IP/Destination IP/Source Port/Destination Port;

Flow start epoch time (in milliseconds);

Flow end epoch time (in milliseconds);

Total uplink/downlink packets;

Total uplink/downlink bytes;

Packet sizes of the first l packets in the uplink;

Packet sizes of the first m packets in the downlink; and

Packet sizes of the first n packets in a bi-direction (in the order in which the packets flow through the gateway 122).

In the example above, the terms “l”, “m”, and “n” may be any number. By way of particular example, l=20, m=20, and n=40.

In addition, the flow analyzer 126 may forward the flow features from the network flows to the classification server 110. According to an example, the classification server 110 may determine which of the network flows corresponds to which of the applications running on the client devices 130a-130n based upon, for instance, the flow features of the network flows and network flow information collected at the client devices 130a-130n. Particularly, as also shown in FIG. 1, each of the client devices 130a-130n is depicted as including an agent 132a-132n that is to collect the network flow information from the respective client devices 130a-130n. The network flow information may be data that corresponds to network traffic generated by an application running on a client device 130a. For instance, the network flow information may identify a mapping between a network socket and a name of an application that is using the network socket to generate network traffic.

By way of particular example, in Linux™, the open socket information is stored in /proc/net/tcp and /proc/net/udp. In this example, the agent 132a may periodically read /proc/net/tcp and /proc/net/udp to extract the open socket information. In these files, each line represents one open socket, and stores the information including a socket tuple <srcip, dstip, src port, dst port>, socket inode, and user identification (UID) that owns this socket. Each mobile application may be assigned with a unique UID at installation time, and may stay the same until the application is uninstalled. Thus, each socket may be tagged with the application which owns the socket and the agent 132a may identify this relationship.

In any regard, the agents 132a-132n may generate respective agent logs that include the network flow information associated with their respective client devices 130a-130n and may communicate the agent logs to the classification server 110, for instance, through the access point 120. The agents 132a-132n may also generate and communicate the agent logs to the classification server 110 at predetermined intervals of time, for instance, every 10 minutes, every 20 minutes, etc., through the access point 120. The interval parameter may be selected to ensure, for instance, that computation costs are kept at a minimum for power saving purposes, and that the agents 132a-132n do not compete with users' normal uses of the applications on the client devices 130a-1320n for computation power. In any regard, the classification server 110 may store the received logs in a data store (not shown) for later processing.

According to an example, the agents 132a-132n are machine readable instructions, e.g., software, installed on the client devices 132a-132n. In another example, the agents 132a-132n are hardware components, e.g., circuits, installed on the client devices 132a-132n. In any case, the agents 132a-132n may be installed on the client devices 132a-132n during or following fabrication of the client devices 132a-132n.

The access point 120 may be a wireless access point, which is generally a device that allows wireless communication devices, such as the clients 130a-130n, to connect to a network 100 using a standard, such as an Institute of Electrical and Electronics Engineers (IEEE) 802.11 standard or other type of standard. Each of the client devices 130a-130n may thus include a wireless network interface for wireless connecting to the network 100 through the access point 120. In addition or alternatively, the access point 120 may be a wired or wireless router, switch, etc., through which the client devices 130a-130n may access the network 100.

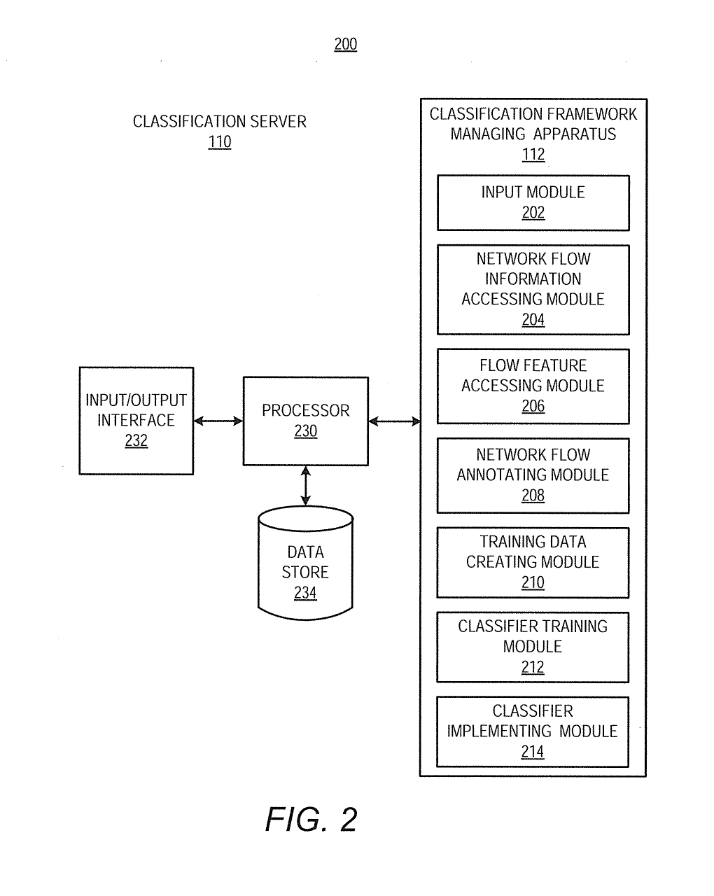

Turning now to FIG. 2, there is shown a simplified block diagram 200 of the classification server 110 depicted in FIG. 1, according to an example. It should be understood that the classification server 110 depicted in FIG. 2 may include additional elements and that some of the elements depicted therein may be removed and/or modified without departing from the scope of the classification server 110.

The classification server 110 is depicted as including the classification framework managing apparatus 112, a processor 230, an input/output interface 232, and a data store 234. The classification framework managing apparatus 112 is also depicted as including an input module 202, a network flow information accessing module 204, a flow feature accessing module 206, a network flow annotating module 208, a training data creating module 210, a classifier training module 212, and a classifier implementing module 214.

The processor 230, which may be a microprocessor, a micro-controller, an application specific integrated circuit (ASIC), and the like, is to perform various processing functions in the classification server 110. One of the processing functions may include invoking or implementing the modules 202-214 of the classification framework managing apparatus 112 as discussed in greater detail herein below. According to an example, the classification framework managing apparatus 112 is a hardware device, such as, a circuit or multiple circuits arranged on a board. In this example, the modules 202-214 may be circuit components or individual circuits.

According to another example, the classification framework managing apparatus 112 is a hardware device, for instance, a volatile or non-volatile memory, such as dynamic random access memory (DRAM), electrically erasable programmable read-only memory (EEPROM), magnetoresistive random access memory (MRAM), memristor, flash memory, floppy disk, a compact disc read only memory (CD-ROM), a digital video disc read only memory (DVD-ROM), or other optical or magnetic media, and the like, on which software may be stored. In this example, the modules 202-214 may be software modules stored in the classification framework managing apparatus 112. According to a further example, the modules 202-214 may be a combination of hardware and software modules.

The processor 230 may store data in the data store 234 and may use the data in implementing the modules 202-214. The data store 234 may be volatile and/or non-volatile memory, such as DRAM, EEPROM, MRAM, phase change RAM (PCRAM), memristor, flash memory, and the like. In addition, or alternatively, the data store 234 may be a device that may read from and write to a removable media, such as, a floppy disk, a CD-ROM, a DVD-ROM, or other optical or magnetic media.

The input/output interface 232 may include hardware and/or software to enable the processor 230 to communicate with devices in the network 100, such as the access point 120 and the flow analyzer 126 is depicted in FIG. 1. The input/output interface 232 may include hardware and/or software to enable the processor 230 to communicate these devices. The input/output interface 232 may also include hardware and/or software to enable the processor 230 to communicate with various input and/or output devices, such as a keyboard, a mouse, a display, etc., through which a user may input instructions into the classification server 110 and may view outputs from the classification server 110.

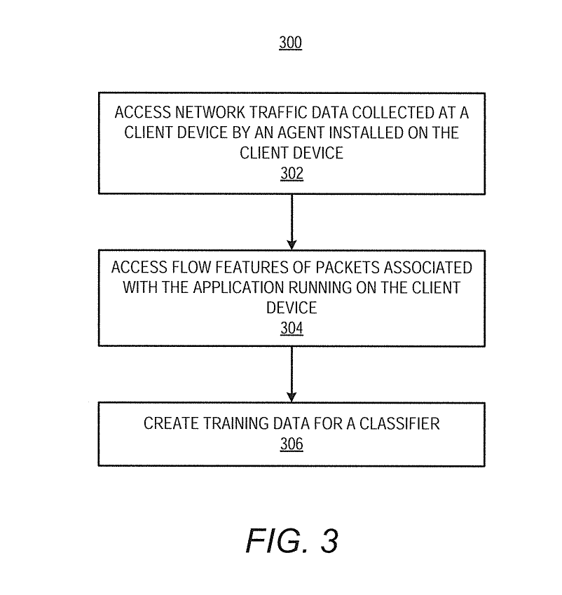

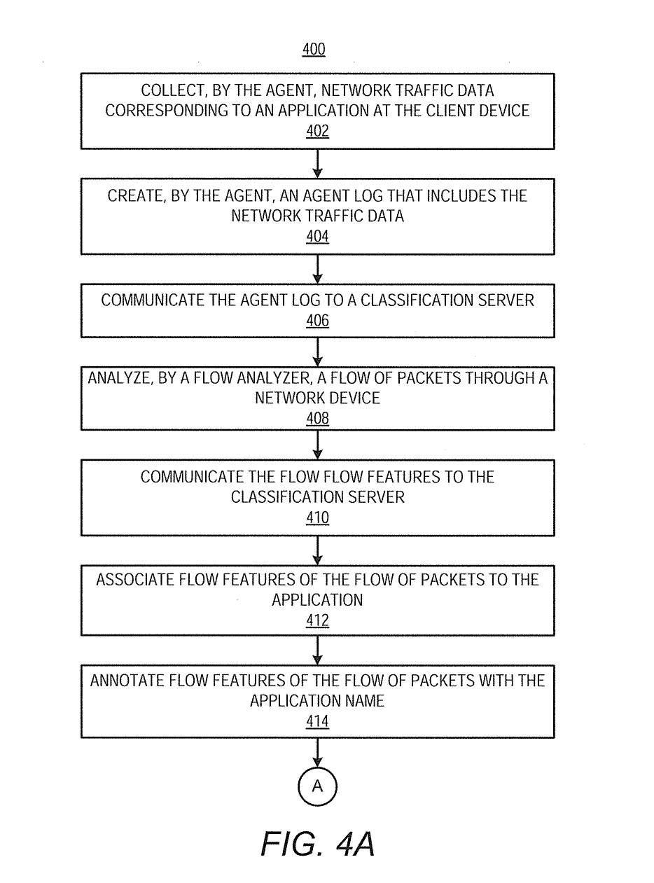

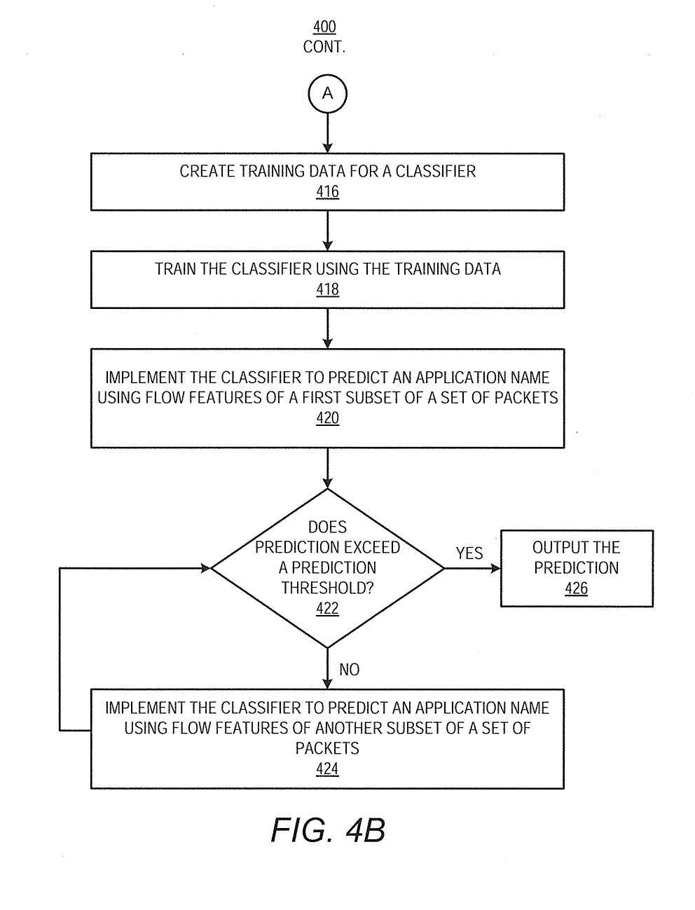

Various manners in which the classification framework managing apparatus 112 in general and the modules 202-214 in particular may be implemented are discussed in greater detail with respect to the methods 300 and 400 depicted in FIGS. 3 and 4A-4B. Particularly, FIGS. 3 and 4A-4B, respectively depict flow diagrams of methods 300 and 400 of managing a classification framework to identify an application name, according to an example. It should be apparent to those of ordinary skill in the art that the methods 300 and 400 represent generalized illustrations and that other operations may be added or existing operations may be removed, modified or rearranged without departing from the scopes of the methods 300 and 400.

With reference first to FIG. 3, at block 302, network flow information collected at a client device 130a by an agent 132a installed on the client device 130 may be accessed, in which the network flow information may be information corresponding to network traffic communicated and/or received by an application running on the client device. For instance, the network flow information accessing module 204 may access the network flow information from the agent 132a through the access point 120. Thus, for instance, the agent 132a may collect information pertaining to the application, including the name of the application, that is currently running on the client device 130a. The agent 132a may also collect information pertaining to a network socket used by the application. In one regard, the agent 132a may be implemented with an application program interface (API) of the client device 130a. In some instances, the agent 132a may be implemented with the client device 132a API with root permission and in other instances, the agent 132a may be implemented with the client device 132a API without root permission.

According to an example, the agent 132a may create an agent log that contains a mapping between the network socket and the application name. In addition, the agent 132a may communicate the agent log to the classification server 110, for instance, through a HTTP POST request. The network flow information accessing module 204 may further store the received agent log in the data store 234 for later processing.

According to an example, the agent log is a CSV file with the following fields, WiFi MAC, device type, dev_ip, local_ip, local_port, remote_ip, remote_port, protocol, uid, start_ts, last_ts, appname, procname, in which the fields may be defined as:

dev_ip: device IP obtained from WLAN DHCP server;

local_ip, local_port, remote_ip, remote_port: extracted from /proc/net/[tcp|udp];

protocol: tcp or udp;

uid: uid field read from /proc/net/[tcp|udp];

start_ts: flow start timestamp in epoch time in millisecond;

last_ts: the latest timestamp of this socket detected by mobile agent, in epoch time in millisecond;

appname: application name; and

procname: process name used by the application.

At block 304, flow features of a plurality of packets that are at least one of communicated by and received by the application running on the client device 132a may be accessed. For instance, the flow feature accessing module 206 may access, e.g., receive, the flow features of the plurality of packets from the flow analyzer 126. As discussed in greater detail herein above, the flow analyzer 126 may determine various flow features of the packets and may communicate those flow features to the classification framework managing apparatus 112. The flow feature accessing module 206 may also store the flow features of the packets associated with the application in the data store 234.

At block 306, training data for a classifier may be created based upon a correlation of the network flow information and the flow features of the packets. For instance, the training data creating module 210 may correlate the accessed flow features of the packets to the accessed network flow information, such that the flow features are annotated with the application name associated with the packets. In one regard, therefore, the training data may accurately correlate the flow features of the packets with the application running on the client device 130a. In addition, because the application name is used in the training data instead of a general class of the application, the training data enables the classifier to be trained using relatively fine grain information.

Although not shown in FIG. 3, the classification server 110 may access network flow information from a plurality of agents 132a-132n in a plurality of client devices 130a-130n. The classification server 110 may also access flow features of a plurality of packets associated with applications running on the client devices 130a-130n. In addition, the classification framework managing apparatus 112 may create training data that correlates the flow features with respective applications running on the client devices 130a-130n. In one regard, therefore, the classification framework managing apparatus 112 may implement network flow information received from the multiple agents 132a-132n to create the training data. For instance, the classifier training module 212 may create the training data based upon an aggregation of respective correlations of the network flow information and the flow features of the plurality of packets originating from applications running on the plurality of client devices 132a-132n.

Turning now to FIG. 4A, at block 402, an agent 132a may collect network flow information corresponding to an application at a client device 130a. The agent 132a may collect the network flow information in any of the manners discussed above with respect to block 302.

At block 404, the agent 132a may create an agent log that includes the network flow information. For instance, the agent 132a may create the agent log to identify a network socket used by the application and a name of the application.

At block 406, the agent 132a may communicate the agent log to the classification server 110. For instance, the agent 132a may communicate the agent log to the classification server 110 through the access point 120 as a HTTP POST request. According to an example, the agent 132a may perform bocks 402-406 iteratively, for instance, every 10 minutes, every 15 minutes, etc.

At block 408, a flow analyzer 126 may analyze a flow of packets through a network device, such as a gateway 122 to the Internet 140. As discussed above, the flow analyzer 126 may extract various flow statistics or features from each network flow identified in pcap logs generated by a sniffer 124.

At block 410, the analyzer 126 may communicate the flow features to the classification server 110.

At block 412, the flow features of the flow of packets may be associated to the application name at the client device 130a. For instance, the flow feature accessing module 206 may determine which of the packets in the flow of packets corresponds to the application at the client device 130a. This determination may be made, for instance, through a comparison of the flow features of the packets and the network socket information contained in the agent log received at block 406.

At block 414, the flow features of the flow of packets may be annotated with the name of the application. For instance, the network flow annotating module 208 may annotate the flow features with the application name to correlate the flow features to the application running on the client device 130a.

Turning now to FIG. 4B, which is a continuation of FIG. 4A, at block 416, training data for a classifier may be created. For instance, the training data creating module 210 may create training data for the classifier that includes the annotated flow features. In one regard, therefore, the training data may be construed as ground truth data and may thus accurately correlate the flow features with the application name.

At block 418, the classifier may be trained using the training data. For instance, the classifier training module 212 may train a machine learning classifier to learn the flow features of a plurality of application names using the training data. The machine learning classifier may be any suitable type of machine learning classifier, for instance, a Naïve Bayes classifier, a support vector machine (SVM) based classifier, a C4.5 or C5.0 based decision tree classifier, etc. A Naïve Bayes classifier is a simple probabilistic classifier based on applying Bayes theorem with strong independence assumptions. This classifier assumes that the flow feature values are independent of each other given the class of the flow sample. However, the flow features need not necessarily be independent. On the other hand, an SVM classifier may build a classifier that maximizes the margin between any two classes corresponding to two application names. In a C4.5 based decision tree classifier, the classification rules may be implemented in a tree fashion where the answer to a decision rule at each node in the tree decides the path along the tree. The C5.0 based decision tree classifier also supports boosting, which is a technique for generating and combining multiple classifiers to improve prediction accuracy. Unlike Naïve Bayes, both SVM based and the decision tree classifiers may take into consideration the dependencies between different flow features. In each of these classifiers, steps may be taken to prevent over-fitting of the classifier to the training data, by using methods such as k-fold cross-validation.

At block 420, the classifier may be implemented to predict an application name associated with a set of packets using flow features of a first subset of the set of packets. For instance, the classifier implementing module 214 may use the trained classifier to predict an application name of an application that communicated and/or received a newly received set of packets. The classifier implementing module 214 may made this prediction using the flow features of a relatively small subset of the set of packets. By way of particular example, the relatively small subset of the set of packets may be 10 packets.

As another example, the classification framework managing apparatus 112 may output the trained classifier to a network device in the network 100. The network device may be any device through which traffic of interest may pass, such that the prediction of the application name associated with the traffic may be performed at real time on the network device.

At block 422, a determination may be made as to whether a prediction accuracy or confidence level of the predicted application name exceeds a prediction threshold. The prediction threshold may be a prediction accuracy threshold or a confidence level threshold. The prediction accuracy threshold may be based upon historical information, such as whether the predicted application name shows historically sufficient prediction accuracy with the number of packets in the subset of packets from which the flow features were used to predict the network traffic type. The confidence level may be a measure regarding a confidence measure of whether a flow sample belongs to each of a plurality of application names. According to an example, a learning algorithm may be used to obtain confidence values of a flow sample belonging to each application name. For example, for a given flow sample, the output of the learning algorithm may be “The flow corresponds to application A with 65% chance, application B with 25% chance, and application C with 10% chance”. Based on this output, the prediction accuracy of labeling the flow with application A is 65%. A user can then decide to either label the flow as application A, or wait for few more packets to re-classify, depending on his choice of threshold accuracy. For example, the user may choose to obtain a prediction accuracy of at least 90%.

The confidence values may be obtained, for instance, through use of the k-nearest neighbor algorithm to identify “k” closest flows from training data, and use of the class distribution of the nearest neighbors to estimate the confidence values. For example, among 100 nearest neighbors from training data, if 70 belong to application A, 25 to application B, and 5 to application C, then the prediction accuracy of labeling the test flow with application A is only 70%. In another example, the confidence values may be obtained as part of the machine learning classifier output.

In response to the predicted application name falling below the prediction threshold, at block 424, the classifier may be implemented to predict an application name associated with the set of packets using flow features of another subset of the set of packets, in which the another subset of the set of packets includes a larger number of packets than the first subset. Thus, for instance, the classifier may wait until additional packets are received, for instance, 5 or more additional packets, and may predict the application name associated with the set of packets using flow features of the another subset of the set of packets. Block 422 may be repeated to make a determination as to whether the predicted network traffic type at block 424 exceeds a prediction threshold. In addition, blocks 422 and 424 may be iterated over a number of times until the accuracy and/or confidence level of the prediction of the application name meets or exceeds the prediction threshold. Thus, for instance, the classifier implementing module 214 or another network device that includes the classifier, may classify the packet flows in multiple stages starting with a relatively small number of packets and working up to increasing numbers of packets until the prediction accuracy threshold is reached. In one regard, therefore, the classifier may attempt to classify the network traffic type of a set of packets with as little resource usage as possible.

At block 426, following a determination that the accuracy and/or confidence level of a predicted application name meets or exceeds the prediction threshold at block 422, the predicted application name may be outputted. For instance, the predicted application name may be outputted for use by another device for any of service differentiation, network engineering, security, accounting, etc.

According to an example, the methods 300 and 400 may be repeated periodically to train the classifier as more and more ground truth data is obtained. In one regard, the periodic re-training of the classifier helps detect and train the classifier with any network traffic pattern changes in the applications running on the client devices 130a-130n, as new applications are installed on the client devices 130a-130d, etc. In one regard, without re-training the classifier, the likelihood that the classifier may falsely predict a new application as another application may be increased. Through implementation of the methods and apparatuses disclosed herein, the agents 132a-132n may collect the updated network flow information associated with the new applications along with their respective application names (or application types). Additionally, the flow analyzer 126 may collect the flow features corresponding to the network traffic that is at least one of communicated and received by the new applications. Moreover, updated training data that includes the network flow information and the flow features corresponding to the new applications may be created and used to re-train the classifier. According to an example, the creation of the updated training data and the re-training of the classifier may occur automatically at predetermined intervals of time, e.g., once a day, once a week, etc. In another example, the accuracy of the application name predications may be tracked and in the event that the application name predication accuracy falls below some predetermined threshold, the updated training data may automatically be created and the classifier may be re-trained.

Some or all of the operations set forth in the methods 300 and 400 may be contained as a utility, program, or subprogram, in any desired computer accessible medium. In addition, the methods 300 and 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

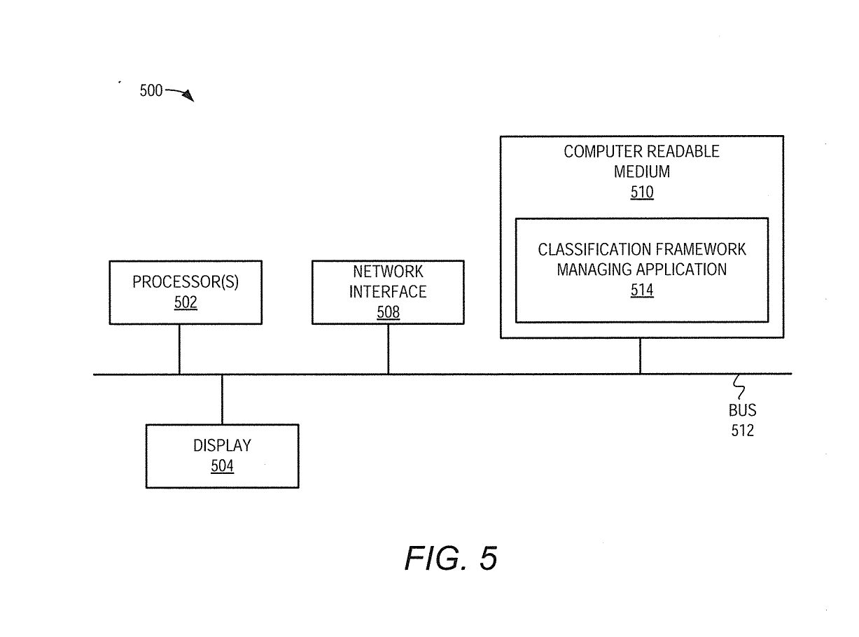

Turning now to FIG. 5, there is shown a schematic representation of a computing device 500, which may be employed to perform various functions of the classification server 110 depicted in FIGS. 1 and 2, according to an example. The device 500 may include a processor 502, a display 504, such as a monitor; a network interface 508, such as a Local Area Network LAN, a wireless 802.11x LAN, a 3G mobile WAN or a WiMax WAN; and a computer-readable medium 510. Each of these components may be operatively coupled to a bus 512. For example, the bus 512 may be an EISA, a PCI, a USB, a FireWire, a NuBus, or a PDS.

The computer readable medium 510 may be any suitable medium that participates in providing instructions to the processor 502 for execution. For example, the computer readable medium 510 may be non-volatile media, such as an optical or a magnetic disk; volatile media, such as memory. The computer-readable medium 510 may also store a classification framework managing application 514, which may perform the methods 300 and 400 and may include the modules of the classification framework managing apparatus 112 depicted in FIG. 2. In this regard, classification framework managing application 514 may include an input module 202, a network flow information accessing module 204, a flow feature accessing module 206, a network flow annotating module 208, a training data creating module 210, a classifier training module 212, and a classifier implementing module 214.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method of managing a classification framework to identify an application name, said method comprising:
accessing network flow information collected at a client device by an agent installed on the client device, wherein the network flow information is information corresponding to network traffic that is at least one of communicated and received by an application running on the client device;
accessing flow features of a plurality of packets that are at least one of communicated and received by the application; and
creating, by a processor, training data for a classifier based upon a correlation of the network flow information and the flow features of the plurality of packets.

2. The method according to claim 1, further comprising:
collecting the network flow information at the client device by the agent;
creating, by the agent, an agent log that includes the network flow information annotated with a name of the application; and
wherein accessing the network flow information further comprises accessing the network flow information from the agent log.

3. The method according to claim 1, wherein the application includes an application name, said method further comprising:
accessing an analysis of a flow of a plurality of packets through a network device;
determining which of the plurality of packets correspond to the network flow information collected at the client device;
annotating flow features of a network flow of the plurality of packets that are at least one of communicated and received by the client device with the application name; and
wherein creating the training data for the classifier further comprises creating the training data to include the annotated flow features.

4. The method according to claim 1, wherein the application includes an application name, said method further comprising:
analyzing flow of a plurality of packets through a network device;
determining which of the plurality of packets correspond to the network flow information collected at the client device;
annotating flow features of a network flow of the plurality of packets that are at least one of communicated and received by the application with the application name; and
wherein creating the training data for the classifier further comprises creating the training data to include the annotated flow features.

5. The method according to claim 1, further comprising:
at each of a plurality of client devices,
collecting network flow information by an agent; and
creating, by the agent, an agent log that includes the network flow information annotated with a name of the application running on the client device; and
accessing the agent logs for each of the plurality of client devices; and
storing the accessed agent logs.

6. The method according to claim 1, further comprising:
accessing network flow information collected at a plurality of client devices by respective agents installed on the plurality of client devices;
accessing flow features of packets originating from the plurality of client devices; and
wherein creating the training data further comprises creating the training data based upon an aggregation of respective correlations of the network flow information and the flow features of the plurality of packets originating from the applications running on the plurality of client devices.

7. The method according to claim 1, further comprising:
training the classifier to identify application names of a plurality of applications based upon the training data; and
implementing the classifier to predict the application name associated with a set of packets that are at least one of communicated and received by an application having the application name.

8. The method according to claim 7, wherein implementing the classifier to predict the application name associated with a set of packets further comprises:
implementing the classifier to predict the application name using flow features of a first subset of the set of packets;
determining whether at least one of an accuracy and a confidence level of the prediction exceeds a prediction threshold;
in response to the at least one of the accuracy and the confidence level of the prediction falling below the prediction threshold, implementing the classifier to predict the application name using flow features of another subset of the set of packets, wherein the another subset of the set of packets includes a larger number of packets than the first subset; and
outputting the prediction of the application name in response to the at least one of the accuracy and the confidence level of the prediction meeting or exceeding the prediction accuracy threshold.

9. A system for managing a classification framework to identify an application type, said system comprising:
a classification server comprising:
a processor; and
a memory on which is stored machine readable instructions that cause the processor to:
receive network flow information collected at a client device by an agent installed on the client device, wherein the network flow information is information corresponding to network traffic that is at least one of communicated and received by an application running on the client device;
receive flow features of a plurality of packets associated with the application; and
create training data for a classifier based upon a correlation of the network flow information and the flow features of the plurality of packets.

10. The system according to claim 9, further comprising:
an agent contained in the client device, wherein the agent is to collect the network flow information at the client device and generate an agent log containing the network flow information, wherein the network flow information includes an identification of a network socket used by the application and a name of the application; and
wherein the machine readable instructions further cause the processor to receive the agent log from the agent.

11. The system according to claim 9, further comprising:
a flow analyzer to extract the flow features from a flow of a plurality of packets flowing through a network device; and
wherein the machine readable instructions further cause the processor to determine which of the plurality of packets correspond to the network flow information collected at the client device based upon the flow features, to annotate the determined flow features of the network flow with the name of the application, and to generate the training data to include the annotated flow features.

12. The system according to claim 9, further comprising:
a plurality of agents contained in a respective client device of a plurality of client devices, wherein each of the agents is to create an agent log that includes the network flow information annotated with a name of the application running on the client device; and
wherein the machine readable instructions are further to receive the agent logs from each of the plurality of agents, to store the accessed agent logs, and to create the training data based upon an aggregation of respective correlations of the network flow information and the flow features of the plurality of packets that are at least one of communicated and received by the applications running on the plurality of client devices.

13. The system according to claim 9, wherein the machine readable instructions are further to train the classifier to identify the application types of a plurality of applications based upon the training data.

14. A non-transitory computer readable storage medium on which is stored machine readable instructions that when executed by a processor are to cause the processor to:
receive network flow information collected at a client device by an agent installed on the client device, wherein the network flow information is information corresponding to network traffic that is at least one of communicated and received by an application running on the client device;
receive flow features of a plurality of packets that are at least one of communicated and received by the application; and
create training data for a classifier based upon a correlation of the network flow information and the flow features of the plurality of packets.

15. The non-transitory computer readable storage medium according to claim 14, wherein the machine readable instructions are further to cause the processor to:
receive network flow information collected at a plurality of client devices by a plurality of agents respectively installed on the plurality of client devices, wherein the network flow information is information corresponding to network traffic that is at least one of communicated and received by a plurality of applications respectively running on the plurality of client devices; and
create the training data based upon an aggregation of respective correlations of the network flow information and the flow features of the plurality of packets that are at least one of communicated and received by the applications.
